(19) United States
(12) Patent Application Publication
(10) Pub. No.: US 2005/0044028 A1
(43) Pub. Date: Feb. 24, 2005

(54) Method, system, and product for providing a graphical and interactive financial planning tool

(75) Inventor: Robert J. Torres, Colleyville, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/645,179

(22) Filed: Aug. 21, 2003

(51) Int. Cl. G06F 17/60

(52) U.S. Cl. 705/36

(57) ABSTRACT

A system, method, and product are disclosed in a data processing system for providing a financial planning tool. A two-dimensional coordinate system having time depicted along a first axis and value depicted along a second axis is displayed. The first axis is divided into multiple time periods. A different investment plan is specified for each time period by specifying assumptions and a percentage allocation. Assumptions are specified regarding projected growth and anticipated contribution for each type of investment. A percentage allocation is specified of all investments to be held among each type of investment. An investment graph is generated, utilizing the coordinate system, that depicts a total value of all investments held as well as a change over time of the total value during each time period. The investment graph is graphically depicted utilizing a graphical user interface in order to provide a financial planning tool.

### BACKGROUND OF THE INVENTION

1. Technical Field

The present invention relates generally to the field of data processing systems, and more specifically to a method, system, and product for providing a visual and interactive financial planning tool. Still more particularly, the present invention relates to a method, system, and product for providing an interactive display of an investment graph that depicts a different investment plan for each one of multiple time periods.

2. Description of Related Art

Current financial planning systems permit a user to enter a current investment value and then track that investment over time assuming a defined rate of growth. For example, known systems permit a user to enter a value for a particular investment, and then track the projected value of the investment assuming the investment always gains a particular interest rate.

In order to produce a realistic investment strategy, however, an investor should take into consideration many different variables. To further complicate matters, investors may have many different investments and many different types of investments. These different types of investments may grow at different rates. It is not possible to easily generate a lifetime investment strategy using the current art.

Therefore, a need exists for a method, system, and product that provides an interactive display of a lifetime investment strategy that depicts a unique investment plan for each one of multiple time periods.

### SUMMARY OF THE INVENTION

A system, method, and product are disclosed in a data processing system for providing a financial planning tool. A two-dimensional coordinate system having time depicted along a first axis and value depicted along a second axis is displayed. The first axis is divided into multiple time periods. A different investment plan is specified for each time period by specifying assumptions and a percentage allocation for each time period. Assumptions are specified regarding projected growth, anticipated contributions, and anticipated expenditures for each type of investment during each time period. A percentage allocation is specified for each time period of all investments to be held among each type of investment. An investment graph is generated, utilizing the coordinate system, that depicts a total value of all investments held as well as a change over time of the total value during each time period. The investment graph is graphically depicted utilizing a graphical user interface in order to provide a financial planning tool. A second investment graph may be generated that depicts an investor's actual investments and then obtains the current market performance for these investments from the markets instead using assumptions. Thus, for each age bracket, an investment plan is determined using actual values of investments and growth in place of assumptions regarding values and growth.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation which depicts a network of data processing systems in accordance with the present invention;

FIG. 2 is a more detailed illustration of a computer system that may be used to implement any of the computer systems of FIG. 1 in accordance with the present invention;

FIG. 3 is a more detailed illustration of a second computer system that may be used to implement any of the computer systems of FIG. 1 in accordance with the present invention;

FIG. 4 illustrates a high level flow chart which depicts initializing a graphical and interactive financial planning tool in accordance with the present invention;

FIGS. 5A-5B depict a high level flow chart which illustrates a graphical and interactive financial planning tool in accordance with the present invention;

FIG. 6 illustrates a graphical user interface that depicts a lifetime investment strategy in accordance with the present invention; and

FIG. 7 illustrates a graphical user interface that depicts a lifetime investment strategy using current investments and actual performance in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

A system, method, and product are disclosed in a data processing system for providing a financial planning tool. The tool provides a visual and interactive graphical depiction of a lifetime investment strategy. The lifetime investment strategy is divided into time periods such as age brackets that each include a range of ages. A total value, and any change in the total value, of all types of investments is depicted for each age bracket.

Assumptions and a percentage allocation are specified for each age bracket. The assumptions include assumptions regarding projected contributions to be made into each type of investment, projected expenditures from any type of investment, and projected growth for each type of investment. In addition, a percentage allocation is specified which describes how the total investments for each time period are allocated among all of the different types of investments.

The present invention is interactive. A user may graphically select and change assumptions and investment plans in order to generate and view a different lifetime investment strategy, e.g., via menus or direct manipulation in a GUI, Web, PDA, or other user interface style and techniques.

Although the specific example depicted herein is a financial planning tool, the present invention is a method, system, and product for visually mapping segments one axis of a two-dimensional coordinate with different processing assumptions. This technique is applicable to industries, domains, and art groups other than merely financial planning.

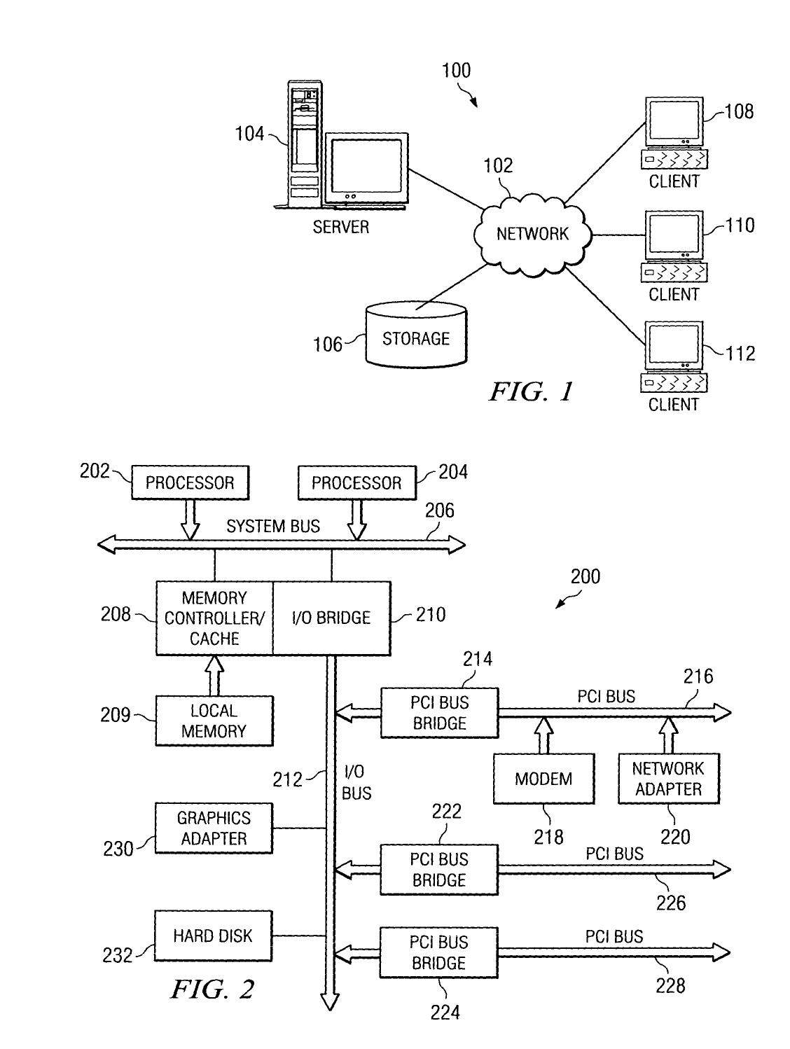

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers, or network computers, or pervasive or other computing devices. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), a wide area network (WAN), or a wireless network. FIG. 1 is intended as an example, and not as an architectural limitation for the present invention.

FIG. 2 is a more detailed illustration of a computer system that may be used to implement any of the computer systems of FIG. 1 in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

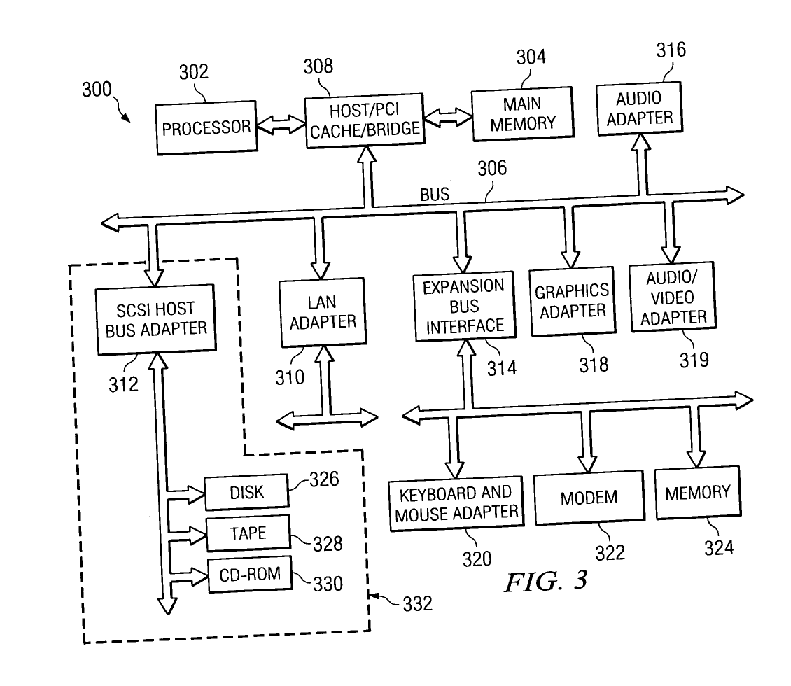

FIG. 3 is a more detailed illustration of a second computer system that may be used to implement any of the computer systems of FIG. 1 in accordance with the present invention. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LLAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance. Any of the depicted data processing systems may be utilized to execute the processes of the present invention.

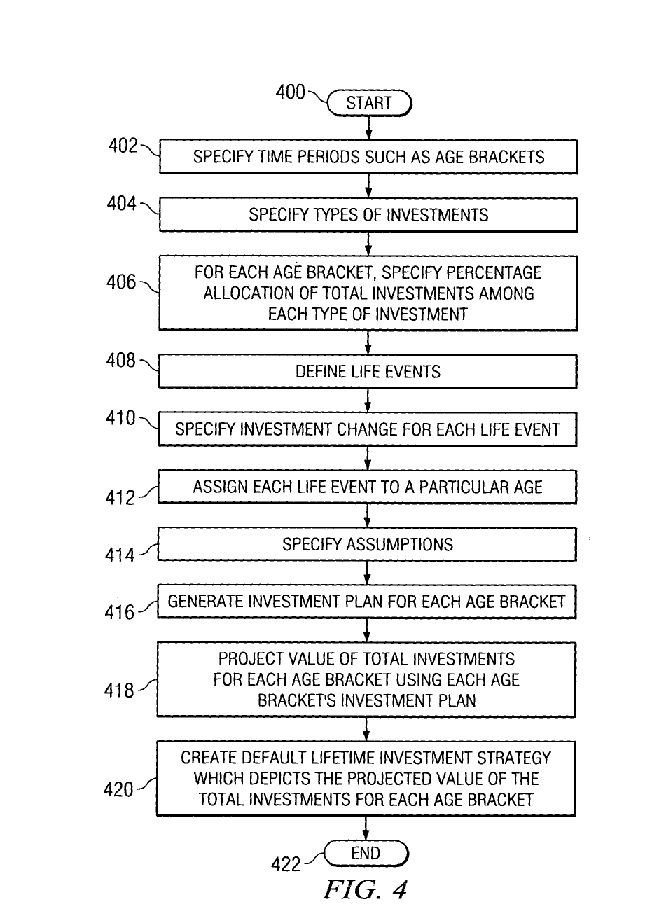

FIG. 4 illustrates a high level flow chart which depicts initializing a graphical and interactive financial planning tool by creating a default lifetime investment strategy in accordance with the present invention. The process starts as illustrated at block 400 and thereafter passes to block 402 which depicts specifying a plurality of time periods. A time period is typically a range of ages. Next, block 404 illustrates specifying a plurality of types of investments. The types include stocks, bonds, cash, and any other type of investment. Block 406, then, depicts specifying for each age bracket the percentage allocation of the total investments among each type of investment. A percentage allocation is specified for each age bracket and may be different for each age bracket. For example, for a range of ages from 46-55, a percentage allocation might be to have the total investment allocated as follows: 90% of the total investment in stocks, 10% of the total investment in bonds, and 0% of the total investment in cash. In addition, for a range of ages from 56-65, a percentage allocation might be to have the total investment during that age range be as follows: 20% of the total investments in stocks, 60% of the total investments in bonds, and 20% of the total investments in case.

The process then passes to block 408 which illustrates defining life events. Life events might include a marriage, birth of a child, college tuition, retirement, and other events that could affect a person's investments. Thereafter, block 410 illustrates specifying an investment change for each life event. For example, a person could specify that at age 45, the person will need to start paying $30,000 per year for a child's college education. Block 412, then, depicts assigning each life event to a particular age. In the example above, the college expenditure is assigned to the age of 45. Thus, when the total of the investments is calculated for the age bracket that includes age 45, this expenditure is taken into account.

Next, block 414 illustrates specifying assumptions that will affect a change in the total investment value for each age bracket. For example, each type of investment may be expected to grow at a particular rate. The rate may vary from one type of investment to another. The rate may also vary for one type of investment from one age bracket to another. Therefore, for each age bracket, a different growth rate may be specified for each type of investment. In addition, a user may be expected to make contributions to the investments and may be expected to make expenditures from the investments. Contributions and expenditures will each affect the total value of the investments. Therefore, for each age bracket, a unique set of assumptions are specified. For example, a user might specify that during a first age bracket, from ages 46-55, a user might contribute $2000 per year to purchase stocks and contribute $1000 per year to purchase bonds. Further, the user could specify that during a second age bracket, from ages 66-75 for example, the user might withdraw $2000 per year from the value of the stocks and receive retirement and social security benefits of $300 per month.

Next, block 416 illustrates generating an investment plan for each age bracket. An investment plan for a particular age bracket includes all of the assumptions and the percentage allocations for the particular age bracket as well as any life events that have been specified for that age bracket. In this mariner, each age bracket, or period of time, has its own unique investment plan. The investment plan generated for an age bracket will be used to calculate the total value of investments for that age bracket. Block 418, then, depicts projecting a value of the total investments for each age bracket using the age bracket's investment plan. Thereafter, block 420 illustrates creating a default lifetime investment strategy which depicts the projected value of the total investments for each age bracket. The projected value for a particular age bracket is calculated using that age bracket's investment plan. The process then terminates as illustrated by block 422.

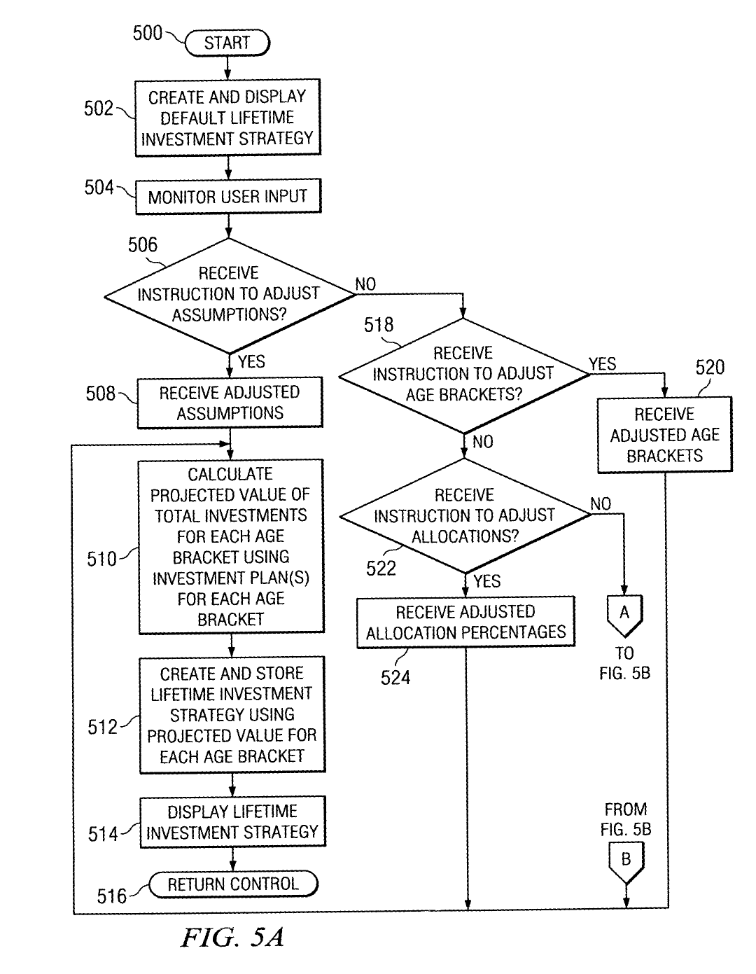

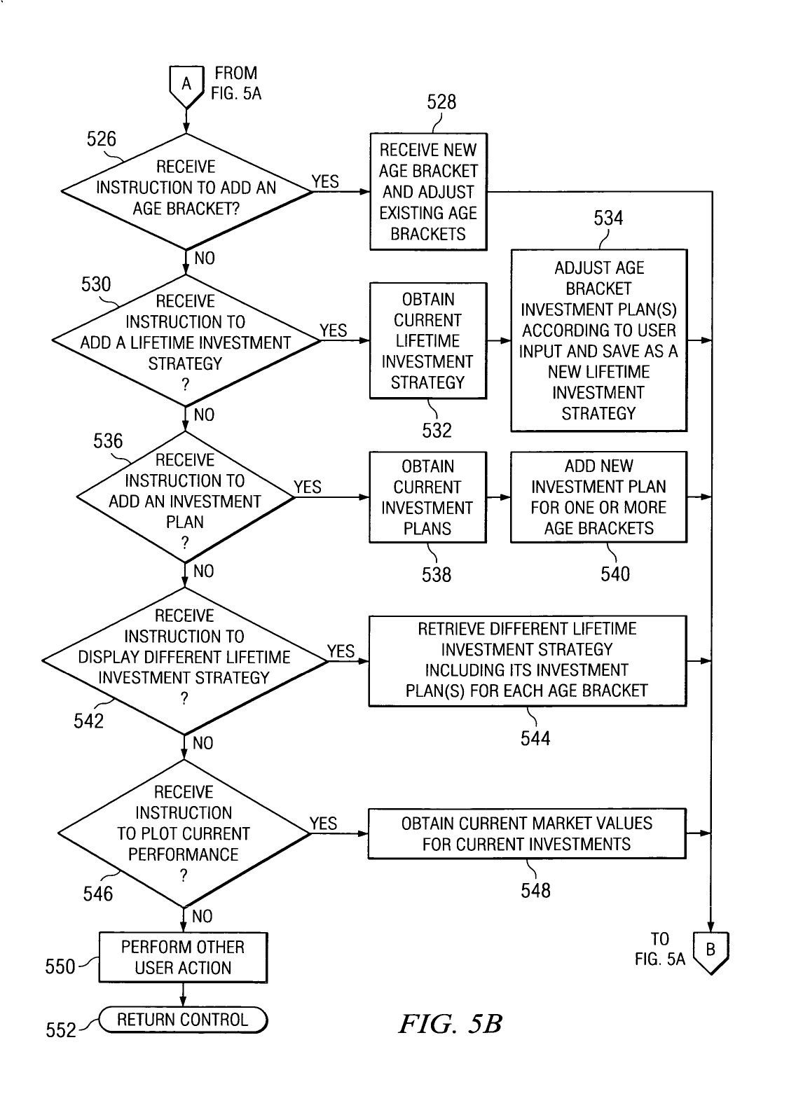

FIGS. 5A-5B depict a high level flow chart which illustrates a graphical and interactive financial planning tool in accordance with the present invention. The process starts as depicted by block 500 and thereafter passes to block 502 which illustrates creating and displaying a default lifetime investment strategy. Block 504, then, depicts monitoring user input. A user may enter a starting value for each type of investment. If a user does not enter a starting value, a default value is used. A user may also enter a starting age. If no starting age is entered, a default age is used. A projected value is calculated for each type of investment for each age bracket using the assumptions and starting values. Then, a total value is determined for each age bracket using the projected value determined for each type of investment and the allocation percentages.

The process then passes to block 506 which illustrates a determination of whether or not an instruction has been received to adjust the assumptions. An instruction may be generated by a user by clicking on a particular portion of the displayed graphical depiction of the lifetime investment strategy. For example, if a user clicked on a particular age bracket or area of the graph that depicts the particular age bracket, the financial planning tool will display the investment plan for that age bracket. All assumptions and the percentage allocation and any life events for that age bracket will be displayed. The user may then alter any of these variables via menu, direct manipulation, or other interaction technique. Altering any of these variables will generate an instruction to adjust the variable. If a determination is made that an instruction has been received to adjust the assumptions, the process passes to block 508 which depicts receiving an adjustment to the assumptions.

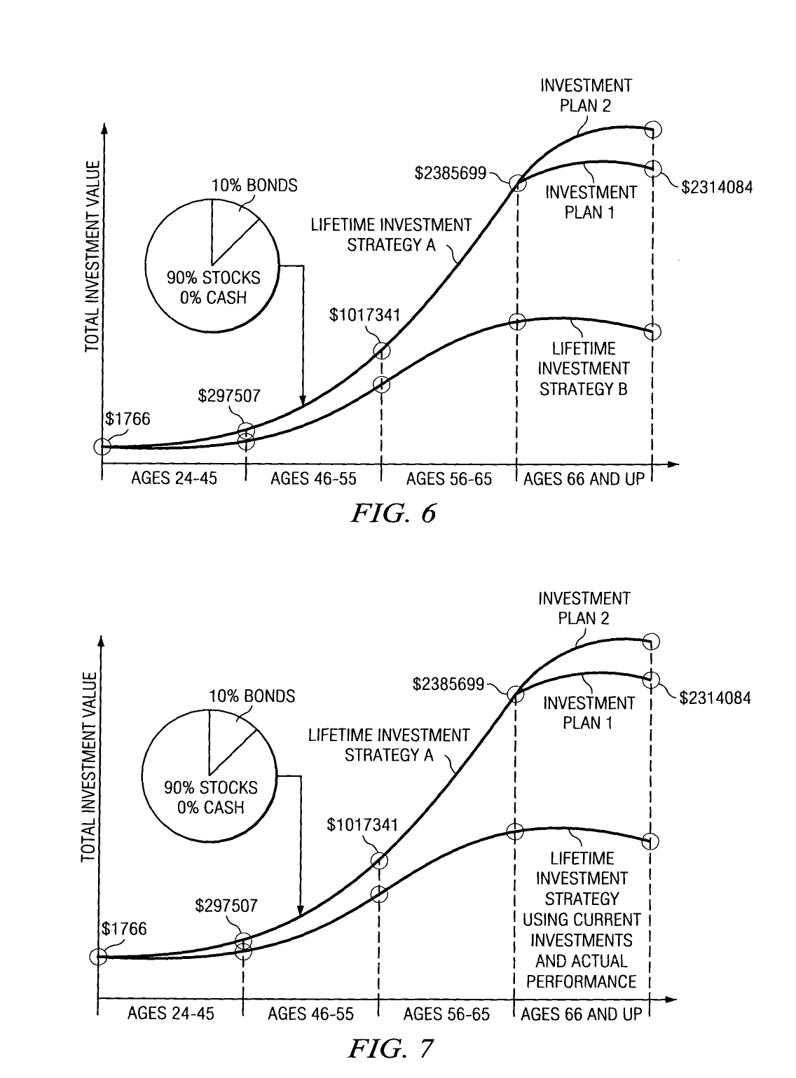

Block 510, then, illustrates calculating the projected value of the total investments for each age bracket using the investment plan(s) for each age bracket. Any adjustments to the assumptions, allocation percentages, age brackets, investment plans, and/or lifetime investment strategies are used in the calculation. Thereafter, block 512 depicts creating an updated lifetime investment strategy using the projected values for each age bracket. Next, block 514 illustrates displaying the lifetime investment strategy using a graphical user interface. An example of a display of a particular lifetime investment strategy using a graphical user interface is depicted by FIG. 6. The process then passes to block 516 which depicts returning control.

Referring again to block 506, if a determination is made that an instruction has not been received to adjust the assumptions, the process passes to block 518 which illustrates a determination of whether or not an instruction has been received to adjust the age brackets, i.e. time periods. If a determination is made that an instruction has been received to adjust the age brackets, the process passes to block 520 which depicts receiving adjusted age brackets. The process then passes back to block 510.

Referring again to block 518, if a determination is made that an instruction has not been received to adjust the age brackets, the process passes to block 522 which illustrates a determination of whether or not an instruction has been received to adjust the allocation percentages. If a determination is made that an instruction has been received to adjust the allocation percentages, the process passes to block 524 which depicts receiving an adjustment to one or more allocation percentages for one or more age brackets. The process then passes back to block 510.

Referring again to block 522, if a determination is made that an instruction has not been received to adjust the allocation percentages, the process passes to block 526 as depicted through connector A. Block 526 illustrates a determination of whether or not an instruction has been received to add an age bracket. If a determination is made that an instruction has been received to add an age bracket, the process passes to block 528 which depicts receiving a new age bracket and adjusting the existing age brackets. The process then passes back to block 510 as illustrated through connector B.

Referring again to block 526, if a determination is made that an instruction has not been received to add an age bracket, the process passes to block 530 which illustrates a determination of whether or not an instruction has been received to add a lifetime investment strategy. If a determination is made that an instruction has been received to add a lifetime investment strategy, the process passes to block 532 which depicts obtaining the current lifetime investment strategy. Next, block 534 illustrates adjusting investment plan(s) for one or more age brackets according to user input. The adjusted investment plan(s) are saved as a new lifetime investment strategy. The process then passes back to block 510 as depicted through connector B.

Referring again to block 530, if a determination is made that an instruction has not been received to add a lifetime investment strategy, the process passes to block 536 which depicts a determination of whether or not an instruction has been received to add an investment plan. If a determination is made that an instruction has been received to an investment plan, the process passes to block 538 which illustrates obtaining the current investment plans for the age brackets. Thereafter, block 540 depicts adding a new investment plan for one or more age brackets. A single lifetime investment strategy may display one or more investment plans simultaneously for a single age bracket. The process then passes back to block 510 as depicted through connector B.

Referring again to block 536, if a determination is made that an instruction has not been received to add an investment plan, the process passes to block 542 which illustrates a determination of whether or not an instruction has been received to display a different lifetime investment strategy. If a determination is made that an instruction has been received to display a different lifetime investment strategy, the process passes to block 544 which depicts retrieving a different lifetime investment strategy including the investment plan(s) for each age bracket. The process then passes back to block 510 as depicted through connector B.

Referring again to block 542, if a determination is made that an instruction has not been received to display a different lifetime investment strategy, the process passes to block 516 which illustrates a determination of whether or not an instruction has been received to plot the current performance of an investor's actual portfolio instead of using assumptions regarding growth. If a determination is made to plot the actual current performance instead of growth assumptions, the process passes to block 518 which depicts obtaining the current market values for investments that an investor has specified. The process then passes back to block 510 as illustrated through connector B.

Referring again to block 516, if a determination is made that an instruction has not been received to plot the current performance, the process passes to block 550 which depicts performing other user action. The process then passes to block 552 which illustrates returning control.

FIG. 6 illustrates a graphical user interface that depicts lifetime investment strategies in accordance with the present invention. Two lifetime investment plans are depicted. A different investment plan is used to generate the projected totals of all investments for each age bracket. Lifetime investment plan A uses a more aggressive set of assumptions and allocations for each age bracket. In addition, two different investment plans are depicted for lifetime investment plan A for age bracket 66 and up. A user has clicked on age bracket 46-55 in order to alter the percentage allocation. Thus, the percentage allocation for age bracket 46-55 is displayed in order to permit a user to alter the percentage allocations.

FIG. 7 illustrates a graphical user interface that depicts a lifetime investment strategy using current investments and actual performance in accordance with the present invention. The second lifetime investment plan strategy an investor's actual investments and then obtains the current market performance for these investments from the markets instead of the growth assumptions. Thus, for each age bracket, an investment plan is determined using actual values of investments and growth in place of assumptions regarding values and growth.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for visually mapping segments of one axis of a two-dimensional coordinate with different processing assumptions, said method comprising the steps of:
displaying said two-dimensional coordinate system having a first variable depicted along a first axis and a second variable depicted along a second axis;
dividing said first axis into a plurality of segments;
specifying a different plurality of assumptions for each one of said plurality of segments;
calculating a value of each one of said plurality of segments utilizing said different plurality of assumptions specified for said each one of said plurality of segments;
generating a graph utilizing said two-dimensional coordinate system that depicts a value of each one of said plurality of segments; and
graphically depicting said graph utilizing a graphical user interface.

2. The method according to claim 1, further comprising the steps of:
graphically receiving a change to an assumption that is specified for one of said plurality of segments;
recalculating a value of said one of said plurality of segments utilizing said change to said assumption; and
generating a graph utilizing said two-dimensional coordinate system that depicts a value of each one of said plurality of segments including said value of said one of said plurality of segments; and
graphically depicting said graph utilizing said graphical user interface.

3. A method in a data processing system for providing a financial planning tool, said method comprising the steps of:
displaying a two-dimensional coordinate system having time depicted along a first axis and value depicted along a second axis;
dividing said first axis into a plurality of time periods;
specifying a different investment plan for each one of said plurality of time periods, said step of specifying further including the steps of:
for each one of said plurality of time periods:
specifying assumptions that affect a change in total investment value for each one of said plurality of time periods; and
specifying a percentage allocation of all investments to be held during each one of said plurality of time periods among each type of a plurality of types of investments;
generating an investment graph utilizing said two-dimensional coordinate system that depicts a total value of all investments held and a change over time of said total value during each one of said plurality of time periods; and
graphically depicting said investment graph utilizing a graphical user interface, said graphical depiction being utilized as a financial planning tool.

4. The method according to claim 3, further comprising the step of:
projecting a value of all investments for each one of said plurality of time periods using said investment plan for each one of said plurality of time periods.

5. The method according to claim 3, wherein said step of specifying assumptions further comprises specifying assumptions regarding projected growth during each one of said plurality of time periods of each type of said plurality of investments.

6. The method according to claim 3, wherein said step of specifying assumptions further comprises obtaining current market performance for a set of specified investments during each one of said plurality of time periods.

7. The method according to claim 3, wherein said step of specifying assumptions further comprises specifying assumptions regarding projected contributions to be made during each one of said plurality of time periods to each type of said plurality of investments.

8. The method according to claim 3, wherein said step of specifying assumptions further comprises specifying assumptions regarding projected expenditures during each one of said plurality of time periods.

9. The method according to claim 3, further comprising the step of:
projecting a value of all investments included in each one of said plurality of time periods using said investment plan specified for each one of said plurality of time periods.

10. The method according to claim 3, further comprising the steps of:
specifying said plurality of types of investments including:
specifying stocks as a type of investment;
specifying bonds as a type of investment; and
specifying cash as a type of investment.

11. The method according to claim 3, further comprising the steps of:
receiving an indication to adjust said assumptions;
calculating new assumptions;
determining an adjustment to said investment plan for each one of said plurality of time periods utilizing said new assumptions;
projecting a new value of all investments included in each one of said plurality of time periods using said adjusted investment plan specified for each one of said plurality of time periods; and
generating an adjusted investment graph utilizing said new value of all investments included in each one of said plurality of time periods using said adjusted investment plan specified for each one of said plurality of time periods.

12. The method according to claim 3, further comprising the steps of:
receiving an indication to adjust said plurality of time periods;
determining an adjustment to said investment plan for each one of said adjusted plurality of time periods;
projecting a new value of all investments included in each one of said adjusted plurality of time periods using said adjusted investment plan specified for each one of said adjusted plurality of time periods; and
generating an adjusted investment graph utilizing said new value of all investments included in each one of said plurality of adjusted time periods using said adjusted investment plan specified for each one of said adjusted plurality of time periods.

13. The method according to claim 3, further comprising the steps of:
receiving an indication to adjust said percentage allocation;
determining an adjustment to said investment plan for each one of said plurality of time periods utilizing said adjusted percentage allocation;
projecting a new value of all investments included in each one of said plurality of time periods using said adjusted investment plan specified for each one of said plurality of time periods; and
generating an adjusted investment graph utilizing said new value of all investments included in each one of said plurality of time periods using said adjusted investment plan specified for each one of said plurality of time periods.

14. The method according to claim 3, further comprising the steps of:
receiving an indication to add a time period;
determining an adjustment to said plurality of time periods and adding said time period to said adjusted plurality of time periods;
projecting a new value of all investments included in each one of said adjusted plurality of time periods; and
generating an adjusted investment graph utilizing said adjusted plurality of time periods.

15. The method according to claim 3, further comprising the steps of:
receiving an indication to add an investment plan for one of said plurality of time periods;
specifying a new investment plan including:
specifying assumptions that affect a change in total investment value for said one of said plurality of time periods; and
specifying a percentage allocation of all investments to be held during said one of said plurality of time periods among each type of said plurality of investments;
projecting a value of all investments included in said one of said plurality of time periods using said new investment plan;
generating an adjusted investment graph utilizing said new value of all investments included in said one of said plurality of time periods using said new investment plan.

16. The method according to claim 3, further comprising the steps of:
receiving an indication to display a second investment graph;
retrieving a second plurality of time periods for said second investment graph;
retrieving a different investment plan for each one of said second plurality of time periods;
projecting a value of all investments for each one of said second plurality of time periods using said investment plan for each one of said second plurality of time periods; and
generating a second investment graph utilizing said value of all investments included in each one of said second plurality of time periods using said investment plan specified for each one of said second plurality of time periods.

17. A computer program product in a data processing system for providing a financial planning tool, said product comprising:
instruction means for displaying a two-dimensional coordinate system having time depicted along a first axis and value depicted along a second axis;
instruction means for dividing said first axis into a plurality of time periods;
instruction means for specifying a different investment plan for each one of said plurality of time periods, said step of specifying further including the steps of:
for each one of said plurality of time periods:
instruction means for specifying assumptions that affect a change in total investment value for each one of said plurality of time periods; and
instruction means for specifying a percentage allocation of all investments to be held during each one of said plurality of time periods among each type of a plurality of types of investments;
instruction means for generating an investment graph utilizing said two-dimensional coordinate system that depicts a total value of all investments held and a change over time of said total value during each one of said plurality of time periods; and
instruction means for graphically depicting said investment graph utilizing a graphical user interface, said graphical depiction being utilized as a financial planning tool.

18. The product according to claim 17, further comprising:
instruction means for projecting a value of all investments for each one of said plurality of time periods using said investment plan for each one of said plurality of time periods.

19. The product according to claim 17, wherein said instruction means for specifying assumptions further comprises instruction means for specifying assumptions regarding projected growth during each one of said plurality of time periods of each type of said plurality of investments.

20. The product according to claim 17, wherein said instruction means for specifying assumptions further comprises instruction means for obtaining current market performance for a set of specified investments during each one of said plurality of time periods.

21. The product according to claim 17, wherein said instruction means for specifying assumptions further comprises instruction means for specifying assumptions regarding projected contributions to be made during each one of said plurality of time periods to each type of said plurality of investments.

22. The product according to claim 17, wherein said instruction means for specifying assumptions further comprises instruction means for specifying assumptions regarding projected expenditures during each one of said plurality of time periods.

23. The product according to claim 17, further comprising:
instruction means for projecting a value of all investments included in each one of said plurality of time periods using said investment plan specified for each one of said plurality of time periods.

24. The product according to claim 17, further comprising:
instruction means for specifying said plurality of types of investments including:
instruction means for specifying stocks as a type of investment;
instruction means for specifying bonds as a type of investment; and
instruction means for specifying cash as a type of investment.

25. The product according to claim 17, further comprising:
instruction means for receiving an indication to adjust said assumptions;
instruction means for calculating new assumptions;
instruction means for determining an adjustment to said investment plan for each one of said plurality of time periods utilizing said new assumptions;
instruction means for projecting a new value of all investments included in each one of said plurality of time periods using said adjusted investment plan specified for each one of said plurality of time periods; and
instruction means for generating an adjusted investment graph utilizing said new value of all investments included in each one of said plurality of time periods using said adjusted investment plan specified for each one of said plurality of time periods.

26. The product according to claim 17, further comprising:
instruction means for receiving an indication to adjust said plurality of time periods;
instruction means for determining an adjustment to said investment plan for each one of said adjusted plurality of time periods;
instruction means for projecting a new value of all investments included in each one of said adjusted plurality of time periods using said adjusted investment plan specified for each one of said adjusted plurality of time periods; and
instruction means for generating an adjusted investment graph utilizing said new value of all investments included in each one of said plurality of adjusted time periods using said adjusted investment plan specified for each one of said adjusted plurality of time periods.

27. The product according to claim 17, further comprising:
instruction means for receiving an indication to adjust said percentage allocation;
instruction means for determining an adjustment to said investment plan for each one of said plurality of time periods utilizing said adjusted percentage allocation;
instruction means for projecting a new value of all investments included in each one of said plurality of time periods using said adjusted investment plan specified for each one of said plurality of time periods; and
instruction means for generating an adjusted investment graph utilizing said new value of all investments included in each one of said plurality of time periods using said adjusted investment plan specified for each one of said plurality of time periods.

28. The product according to claim 17, further comprising:
instruction means for receiving an indication to add a time period;
instruction means for determining an adjustment to said plurality of time periods and adding said time period to said adjusted plurality of time periods;
instruction means for projecting a new value of all investments included in each one of said adjusted plurality of time periods; and
instruction means for generating an adjusted investment graph utilizing said adjusted plurality of time periods.

29. The product according to claim 17, further comprising:
instruction means for receiving an indication to add an investment plan for one of said plurality of time periods;
specifying a new investment plan including:
instruction means for specifying assumptions that affect a change in total investment value for said one of said plurality of time periods; and
instruction means for specifying a percentage allocation of all investments to be held during said one of said plurality of time periods among each type of said plurality of investments;
instruction means for projecting a value of all investments included in said one of said plurality of time periods using said new investment plan;
instruction means for generating an adjusted investment graph utilizing said new value of all investments included in said one of said plurality of time periods using said new investment plan.

30. The product according to claim 17, further comprising:
instruction means for receiving an indication to display a second investment graph;
instruction means for retrieving a second plurality of time periods for said second investment graph;
instruction means for retrieving a different investment plan for each one of said second plurality of time periods;
instruction means for projecting a value of all investments for each one of said second plurality of time periods using said investment plan for each one of said second plurality of time periods; and
instruction means for generating a second investment graph utilizing said value of all investments included in each one of said second plurality of time periods using said investment plan specified for each one of said second plurality of time periods.

31. A data processing system for providing a financial planning tool, said system comprising:
a two-dimensional coordinate system having time depicted along a first axis and value depicted along a second axis;
said first axis being divided into a plurality of time periods;
a different investment plan being specified for each one of said plurality of time periods, said step of specifying further including the steps of:
for each one of said plurality of time periods:
assumptions that affect a change in total investment value specified for each one of said plurality of time periods; and
a percentage allocation of all investments to be held during each one of said plurality of time periods specified among each type of a plurality of types of investments;
an investment graph being generated utilizing said two-dimensional coordinate system that depicts a total value of all investments held and a change over time of said total value during each one of said plurality of time periods; and
a graphical user interface for graphically depicting said investment graph, said graphical depiction being utilized as a financial planning tool.

32. The system according to claim 31, further comprising:
a value of all investments being projected for each one of said plurality of time periods using said investment plan for each one of said plurality of time periods.

33. The system according to claim 31, wherein said assumptions further comprise assumptions specified regarding projected growth during each one of said plurality of time periods of each type of said plurality of investments.

34. The system according to claim 31, wherein said assumptions further comprise current market performance obtained for a set of specified investments during each one of said plurality of time periods.

35. The system according to claim 31, wherein said assumptions further comprise assumptions specified regarding projected contributions to be made during each one of said plurality of time periods to each type of said plurality of investments.

36. The system according to claim 31, wherein said assumptions further comprise assumptions specified regarding projected expenditures during each one of said plurality of time periods.

37. The system according to claim 31, further comprising:
a value being projected of all investments included in each one of said plurality of time periods using said investment plan specified for each one of said plurality of time periods.

38. The system according to claim 31, further comprising:
said plurality of types of investments including:
stocks as a type of investment;
bonds as a type of investment; and
cash as a type of investment.

39. The system according to claim 31, further comprising:
an indication being received to adjust said assumptions;
new assumptions being calculated;
an adjustment to said investment plan being determined for each one of said plurality of time periods utilizing said new assumptions;
a new value being projected of all investments included in each one of said plurality of time periods using said adjusted investment plan specified for each one of said plurality of time periods; and
an adjusted investment graph being generated utilizing said new value of all investments included in each one of said plurality of time periods using said adjusted investment plan specified for each one of said plurality of time periods.

40. The system according to claim 31, further comprising:
an indication to adjust said plurality of time periods being received;
an adjustment to said investment plan determined for each one of said adjusted plurality of time periods;
a new value of all investments included in each one of said adjusted plurality of time periods projected using said adjusted investment plan specified for each one of said adjusted plurality of time periods; and
adjusted investment graph generated utilizing said new value of all investments included in each one of said plurality of adjusted time periods using said adjusted investment plan specified for each one of said adjusted plurality of time periods.

41. The system according to claim 31, further comprising:
an indication to adjust said percentage allocation being received;
an adjustment to said investment plan determined for each one of said plurality of time periods utilizing said adjusted percentage allocation;
a new value of all investments included in each one of said plurality of time periods projected using said adjusted investment plan specified for each one of said plurality of time periods; and
an adjusted investment graph generated utilizing said new value of all investments included in each one of said plurality of time periods using said adjusted investment plan specified for each one of said plurality of time periods.

42. The system according to claim 31, further comprising:
an indication to add a time period being received;
an adjustment to said plurality of time periods determined and said time period added to said adjusted plurality of time periods;
a new value of all investments included in each one of said adjusted plurality of time periods projected; and
an adjusted investment graph generated utilizing said adjusted plurality of time periods.

43. The system according to claim 31, further comprising:
an indication to add an investment plan received for one of said plurality of time periods;
a new investment plan including:
assumptions that affect a change in total investment value for said one of said plurality of time periods; and
a percentage allocation of all investments to be held during said one of said plurality of time periods among each type of said plurality of investments;
a value of all investments included in said one of said plurality of time periods projected using said new investment plan;
an adjusted investment graph generated utilizing said new value of all investments included in said one of said plurality of time periods using said new investment plan.

44. The system according to claim 31, further comprising:
an indication to display a second investment graph being received;
a second plurality of time periods retrieved for said second investment graph;
a different investment plan retrieved for each one of said second plurality of time periods;
a value of all investments projected for each one of said second plurality of time periods using said investment plan for each one of said second plurality of time periods; and
a second investment graph generated utilizing said value of all investments included in each one of said second plurality of time periods using said investment plan specified for each one of said second plurality of time periods.
